(19) United States
(12) Patent Application Publication
(10) Pub. No.: US 2014/0100835 A1
(43) Pub. Date: Apr. 10, 2014

(54) User Behavior Modeling for Intelligent Mobile Companions

(71) Applicant: Futurewei Technologies, Inc., Plano, TX (US)

(72) Inventors: Ishita Majumdar, Fremont, CA (US); John Waclawsky, Bartlett, IL (US); George Vanecek, Madison, WI (US); Chris Bedford, Mountain View, CA (US); Tim Tran, San Jose, CA (US); Gayathri Namasivayam, Buffalo Grove, IL (US)

(73) Assignee: Futurewei Technologies, Inc., Plano, TX (US)

(21) Appl. No.: 14/046,770

(22) Filed: Oct. 4, 2013

Related U.S. Application Data
(60) Provisional application No. 61/709,759, filed on Oct. 4, 2012.

(51) Int. Cl. G06N 3/00

(52) U.S. Cl. CPC G06N 3/00
USPC 703/11

(57) ABSTRACT

An apparatus for modeling user behavior comprising at least one sensor for sensing a parameter, a memory, a processor coupled to the sensor and the memory, wherein the memory contains instructions that when executed by the processor cause the apparatus to collect a first data from the sensor, fuse the sensor data with a time element to obtain a context-feature, determine a first state based on the context-feature, record the first state in a state repository, wherein the state repository is configured to store a plurality of states such that the repository enables time-based pattern identification, and wherein each state corresponds to a user activity, incorporate information stored in the state repository into a behavior model, and predict an expected behavior based on the behavior model.

### CROSS-REFERENCE TO RELATED APPLICATION

The present application claims priority to U.S. Provisional Patent Application No. 61/709,759, filed Oct. 4, 2012 by Ishita Majumdar, et al., titled “Method to Develop User Behavior Model for Building Intelligent Mobile Companion,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The proliferation of mobile devices continues unabated. Users are increasingly turning to so-called smart devices to augment and direct daily activities. However, improved learning and anticipation of end-user behavior would improve the usefulness of smart devices in fulfilling the role of electronic mobile intelligent companions that recommend, guide, and direct end user behavior.

Modern mobile devices may comprise a variety of input/output (I/O) components and user interfaces are used in a wide variety of electronic devices. Mobile devices such as smartphones increasingly integrate a number of functionalities for sensing physical parameters and/or interacting with other devices, e.g., global positioning system (GPS), wireless local area networks (WLAN) and/or wireless fidelity (WiFi), Bluetooth, cellular communication, near field communication (NFC), radio frequency (RF) signal communication, etc. Mobile devices may be handheld devices, such as cellular phones and/or tablets, or may be wearable devices. Mobile devices may be equipped with multiple-axis (multiple-dimension) input systems, such as displays, keypads, touch screens, accelerometers, gyroscopic sensors, microphones, etc.

### SUMMARY

In one embodiment, the disclosure includes an apparatus for modeling user behavior comprising at least one sensor for sensing a parameter, a memory, a processor coupled to the sensor and the memory, wherein the memory contains instructions that when executed by the processor cause the apparatus to collect a first data from the sensor, fuse the sensor data with a time element to obtain a context-feature, determine a first state based on the context-feature, record the first state in a state repository, wherein the state repository is configured to store a plurality of states such that the repository enables time-based pattern identification, and wherein each state corresponds to a user activity, incorporate information stored in the state repository into a behavior model, and predict an expected behavior based on the behavior model.

In another embodiment, the disclosure includes a method of modeling user behavior for a platform on a mobile device, comprising collecting a plurality of time-based data from a plurality of sensors, analyzing the data to determine a plurality of states, wherein each state corresponds to a real-world activity being performed by a user, recording the plurality of states in a state repository, incorporating information stored in the state repository into a behavior model, wherein building the behavior model comprises applying one or more behavior algorithms to the state repository in order to identify one or more behavior patterns, predicting an expected behavior based on the behavior model, and sending instructions to perform an action to at least one hardware component, software application, or both based on the expected behavior.

In yet another embodiment, the disclosure includes a computer program product comprising computer executable instructions stored on a non-transitory medium that when executed by a processor cause the processor to collect a plurality of data from a mobile device over a time interval, wherein the data comprises low-level, mid-level, and high-level data, fuse the data with time information to create a plurality of context-features, utilize the plurality of context-features to determine a plurality of states, wherein each state corresponds to a real-world activity being performed by a user, record the plurality of states in a state repository, incorporate information stored in the state repository into a behavior model, wherein building the behavior model comprises applying one or more behavior algorithms to the state repository in order to identify one or more behavior patterns, and identify an action to be taken by the mobile device based on an expected state, wherein the expected state is based on the behavior model.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a mobile node (MN).

FIG. 2 is a schematic diagram of an embodiment of a user behavior modeling platform.

FIG. 3 is a flowchart showing a method of modeling user behavior for intelligent mobile companions.

FIG. 4 is a behavior vector timeline representing a portion of an example user's behavior on an average day.

FIG. 5 is a flowchart illustrating a method of execution of an action based on a predicted user behavior.

FIG. 6 is a flowchart showing an example use of a user behavior modeling platform.

FIG. 7 is a flowchart showing an example use of a user behavior modeling platform to suggest a traffic-managed alternate route.

FIG. 8 is a flowchart showing an example use of a user behavior modeling platform to suggest a conditional action.

FIG. 9 is a flowchart showing an example use of a user behavior modeling platform to run a context-aware power management (CAPA) routine.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

This disclosure includes determining a sequence of user behaviors from an analysis of passively-obtained or actively-obtained fused and/or correlated data activities, predicting user behaviors based on the analysis, and permitting anticipation of users' needs/desires, e.g., by building a comprehensive model of periodic user behavior. Thus, disclosed systems may provide ways to predict future behavior and infer needs by developing a model of behavior patterns, which may further allow for proactive actions to be taken by the platform, also referred to as an intelligent mobile companion or virtual assistant. This disclosure therefore includes correlating past and current user activities as recognized through a set of sensors in order to recognize patterns of user behavior and anticipate future user needs.

This disclosure further includes a user behavior modeling platform, which may alternately be referred to as a Mobile Context-Aware (MOCA) platform, designed for mobile devices that provides local client application information about the device user's real time activity, including both motion states and application usage state. Client applications may include a CAPA application for optimizing the device's battery power by reducing the energy consumption based on the activity performed by the user. The CAPA application may comprise a dynamic power optimization policy engine configured to assess, record, learn, and be responsive to particular users' current and/or expected usage behaviors, habits, trends, locations, environments, and/or activities.

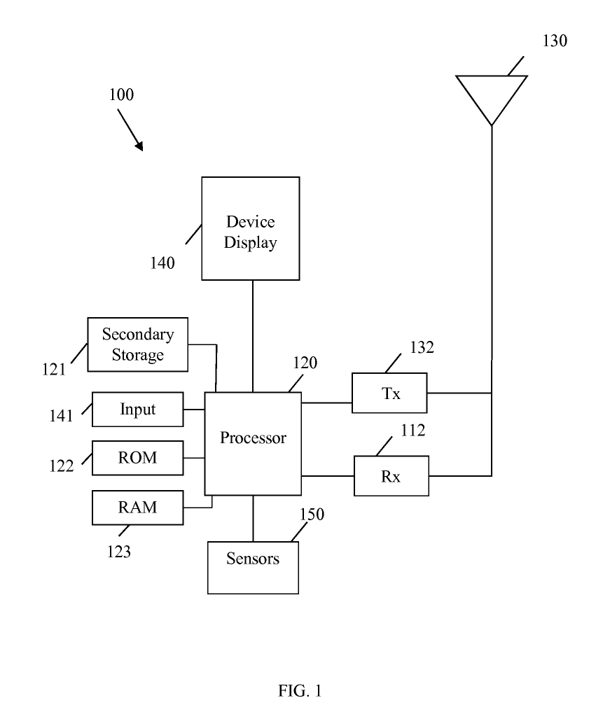

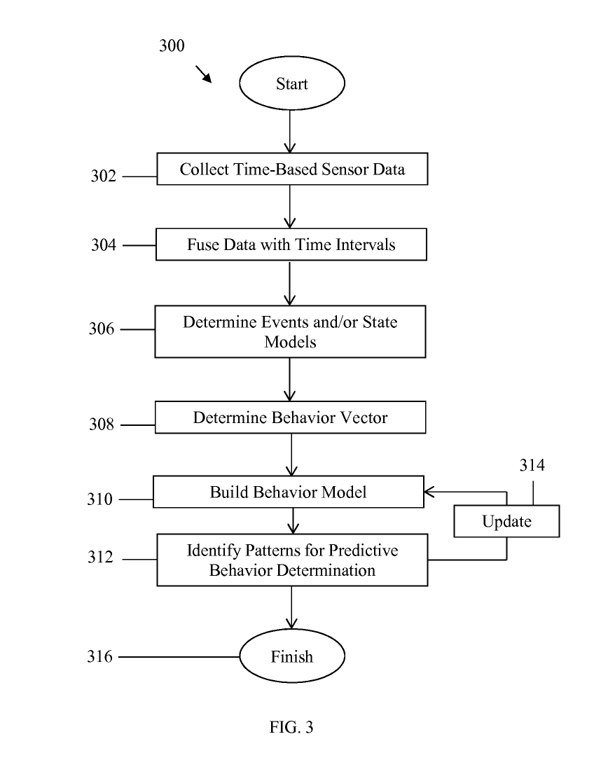

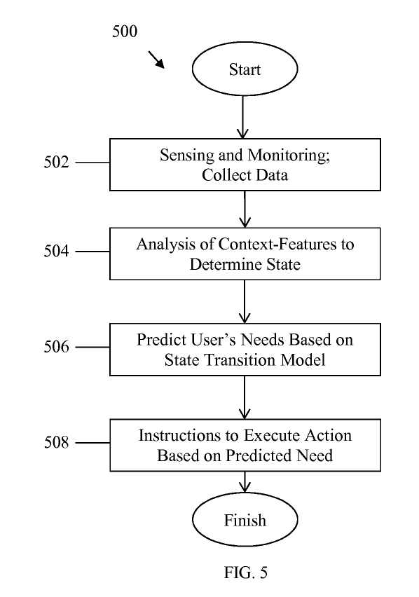

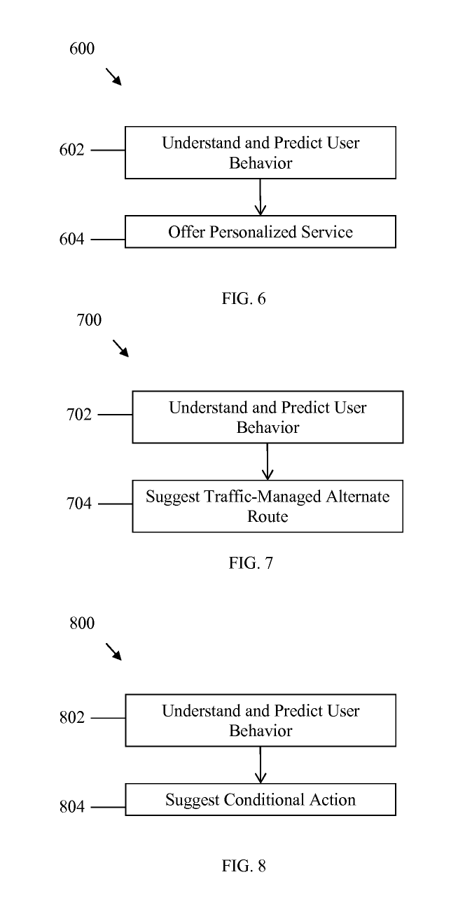

FIG. 1 is a schematic diagram of an embodiment of a MN 100, which may comprise hardware and/or software components sufficient to carry out the techniques described herein. MN 100 may comprise a two-way wireless communication device having voice and/or data communication capabilities. In some aspects, voice communication capabilities are optional. The MN 100 generally has the capability to communicate with other computer systems on the Internet and/or other networks. Depending on the exact functionality provided, the MN 100 may be referred to as a data messaging device, a tablet computer, a two-way pager, a wireless e-mail device, a cellular telephone with data messaging capabilities, a wireless Internet appliance, a wireless device, a smart phone, a mobile device, or a data communication device, as examples. At least some of the features/methods described in the disclosure, for example method 300 of FIG. 3, method 500 of FIG. 5, method 600 of FIG. 6, method 700 of FIG. 7, and/or method 800 of FIG. 8, may be implemented in in a MN such as MN 100.

MN 100 may comprise a processor 120 (which may be referred to as a central processor unit or CPU) that may be in communication with memory devices including secondary storage 121, read only memory (ROM) 122, and random access memory (RAM) 123. The processor 120 may be implemented as one or more general-purpose CPU chips, one or more cores (e.g., a multi-core processor), or may be part of one or more application specific integrated circuits (ASICs) and/or digital signal processors (DSPs). The processor 120 may be implemented using hardware, software, firmware, or combinations thereof.

The secondary storage 121 may be comprised of one or more solid state drives and/or disk drives which may be used for non-volatile storage of data and as an over-flow data storage device if RAM 123 is not large enough to hold all working data. Secondary storage 121 may be used to store programs that are loaded into RAM 123 when such programs are selected for execution. The ROM 122 may be used to store instructions and perhaps data that are read during program execution. ROM 122 may be a non-volatile memory device with a small memory capacity relative to the larger memory capacity of secondary storage 121. The RAM 123 may be used to store volatile data and perhaps to store instructions. Access to both ROM 122 and RAM 123 may be faster than to secondary storage 121.

MN 100 may be any device that communicates data (e.g., packets) wirelessly with a network. The MN 100 may comprise a receiver (Rx) 112, which may be configured for receiving data, packets, or frames from other components. The receiver 112 may be coupled to the processor 120, which may be configured to process the data and determine to which components the data is to be sent. The MN 100 may also comprise a transmitter (Tx) 132 coupled to the processor 120 and configured for transmitting data, packets, or frames to other components. The receiver 112 and transmitter 132 may be coupled to an antenna 130, which may be configured to receive and transmit wireless (radio) signals.

The MN 100 may also comprise a device display 140 coupled to the processor 120, for displaying output thereof to a user. The device display 140 may comprise a light-emitting diode (LED) display, a Color Super Twisted Nematic (CSTN) display, a thin film transistor (TFT) display, a thin film diode (TFD) display, an organic LED (OLED) display, an active-matrix OLED display, or any other display screen. The device display 140 may display in color or monochrome and may be equipped with a touch sensor based on resistive and/or capacitive technologies.

The MN 100 may further comprise input devices 141 coupled to the processor 120, which may allow a user to input commands, e.g., via a keyboard, mouse, microphone, vision-based camera, etc., to the MN 100. In the case that the display device 140 comprises a touchscreen and/or touch sensor, the display device 140 may also be considered an input device 141. In addition to and/or in the alternative, an input device 141 may comprise a mouse, trackball, built-in keyboard, external keyboard, and/or any other device that a user may employ to interact with the MN 100. The MN 100 may further comprise sensors 150 coupled to the processor 120. Sensors 150 may detect and/or measure conditions in and/or around MN 100 at a specified time and transmit related sensor input and/or data to processor 120.

It is understood that by programming and/or loading executable instructions onto the MN 100, at least one of the receiver 112, processor 120, secondary storage 121, ROM 122, RAM 123, antenna 130, transmitter 132, input device 141, display 140, and/or sensors 150, are changed, transforming the NE 100 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

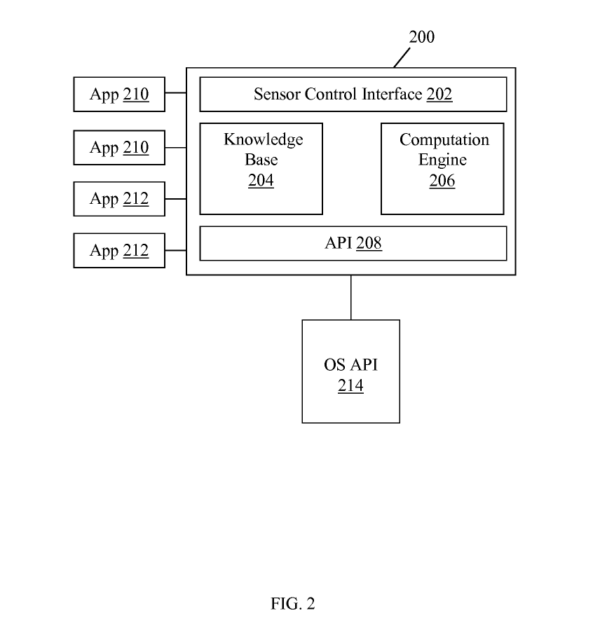

FIG. 2 is a schematic diagram of an embodiment of a user behavior modeling platform 200. The platform 200 may be instantiated on a device, e.g., MN 100 of FIG. 1 or in other a system server, e.g., with data collection occurring remotely. The platform 200 may be run continuously as a background application or integrated into the operating system of a device. The platform 200 may comprise a Sensor Control Interface (SCI) 202 for receiving data, e.g., from platform sensors, from the operating system (OS) application programming interface (API) 214, and/or from software applications (apps) 210. The platform 200 may include a knowledge base 204 for storing information about the user's conduct and/or the user's environment, e.g., context-features, explained further herein, state/behavior of the user, explained further herein, over various time intervals, learned state-transition patterns of the user, etc. The knowledge base 204 may further comprise the rules, constraints, and/or learning algorithms for processing the raw data, extracting user context-features, recognizing the state and/or behavior of the user based on the context-features, and learning any user-specific behavior-transition and/or state-transition pattern(s). In some embodiments, the knowledge base 204 may comprise data populated by a remote data supplier, e.g., preferences of companions pushed to the device from a centralized server. The platform 200 may include a computation engine 206 for applying any rules, constraints, and/or algorithms to the data to derive new information. The computation engine 206 may analyze, correlate, and transform the raw data into meaningful information, may detect trends and/or repetitive patterns, and may offer predictions. The platform 200 may comprise an API 208 for sending user information, e.g., user context-features, state transition models, etc., to client apps 212 configured to receive such information.

FIG. 3 is a flowchart showing a method 300 of modeling user behavior for intelligent mobile companions. At 302, a user device, e.g., MN 100 of FIG. 1, may collect sensor data, e.g., via the sensor control interface 202 of FIG. 2, to assist in determining the user's usage context, e.g., time-based sensor data (e.g., elapsed time, time stamp, estimated time of arrival, planned calendar meeting length, etc.), app data (e.g., from apps 210 and/or client apps 212 of FIG. 2, usage statistics), and/or environmental data using data from integral sensors (e.g., GPS, WiFi, Bluetooth, cellular, NFC, RF, acoustic, optic, etc.) or from external sensors (e.g., collected from a remote or peripheral device). Additionally, the sensor data may include user-generated content and machine-generated content to develop app profiles and/or app usage metrics. User-generated content may include, e.g., sending email, sending Short Messaging Service (SMS) texts, browsing the internet, contacts from a contact list utilized during session, most-used applications, most navigated destinations, must frequently emailed contacts from a contact list, touchscreen interactions per time interval, etc. Machine-generated content may include various app usage time-based and hardware/software activity-based metrics, e.g., time app started, time app shutdown, concurrently running apps (including, e.g., the app's running status as background or foreground app), app switching, volume levels, touchscreen interactions per time interval, etc. App profiles within the behavior model may record correlations of apps with associated activities and/or resources, e.g., associating a streaming video app with the activity label “video” and display, audio, and WiFi resources, may map particular apps with their associated power consumption levels, etc. Step 302 may further include filtering and canonicalization of raw sensor data. Canonicalization may be defined as the process of putting data into a standard form through operations such as standardization of units of measurement. For example, raw data from a light meter given in foot candles may be translated into lux, temperatures may be converted from Fahrenheit to Celsius, etc. At 304, the device may fuse sensor data with time intervals, e.g., by applying one or more rules, constraints, learning algorithms, and/or data fusion algorithms to distill and analyze multiple levels of data and derive implied information, permitting the system to deduce likely conclusions for particular activities. Acceptable fusing sensor data algorithms may include Kalman Filter approach using state fusion and/or measurement fusion, Bayesian algorithms, Correlation regression methodologies, etc. At 306, the device may translate digital streams of collected sensor data into state descriptions with human understandable labels, e.g., using classifiers. Classifiers may be used to map sensor and app data to states. In other words, at 306 the device may determine events and/or state models based on certain context-features, e.g., location (e.g., at home, at work, traveling, etc.), apps in use (e.g., navigation, video, browser, etc.), travel mode (e.g., still, walking, running, in a vehicle, etc.), environment (e.g., using a microphone to determine ambient and/or localized noise levels, optical sensors, a camera, etc.), activity data (e.g., on a call, in a meeting, etc.), by applying one or more classification algorithms as described further herein. Additionally, combinations and permutations of sensor-driven context-features may inform the device about events and/or states. For example, a GPS and accelerometer may indicate that a user is walking, running, driving, traveling by train, etc. A light sensor and a GPS sensor may indicate that a user is in a darkly lit movie theater. A WiFi receiver and a microphone may indicate that the user is in a crowded coffee shop. Those of ordinary skill in the art would readily recognize other such examples of utilizing sensor information to determine a user's context, events and/or states. In some embodiments, analysis may include applying K-means clustering or other clustering algorithms, e.g., vector quantization algorithms, to identify a cluster of vectors, Hidden Markov Models (HMM), utilizing particle filters for a variant of Bayes filtering for modeling travel mode, expectation-maximization for learning travel patterns from GPS sensors, naïve Bayes classifiers, k-Nearest Neighbor (k-NN), support vector machines (SVM), decision trees, and/or decision tables for classifying the activity of a user based on accelerometer readings, etc. Those of skill in the art will recognize other such applicable analytical methods, techniques and tools. Some embodiments may utilize socially large-scale preference correlations to develop an individualized adaptive provision of services. For example, people who like X generally like Y; the user likes X, therefore it is likely that the user may like Y. These and other techniques will be readily apparent to those of ordinary skill in the art. At 308, the device may determine a particular behavior vector, e.g., by applying one or more behavior algorithms as described further herein. Acceptable behavior algorithms based on learning algorithms may include decision trees, association rule learning algorithms, neural networks, clustering, reinforcement learning, etc. At 310, the device may build a repository and/or behavior model, collectively referred to herein as a state transition model or a finite state model, of individual user behaviors, e.g., by building a repository of individual user behaviors. At 312, the device may apply a pattern recognition analysis to identify sequential patterns for the performance of responsive and/or predictive operations. Acceptable pattern recognition algorithms may include k-mean algorithms, HMMs, conditional random fields, etc. At 314, the device may update the state transition model based on the results of the analysis performed at 312. Updating the state transition model may comprise using state transition algorithm (STA), harmonic searches, etc. In some embodiments, updating may be continuous, while in other embodiments updating may be periodic or event-based. At 316, the method 300 may terminate. In some embodiments, termination may comprise returning instructions to the user device instructing execution of an action based on the predicted behavior, as explained further under FIG. 5.

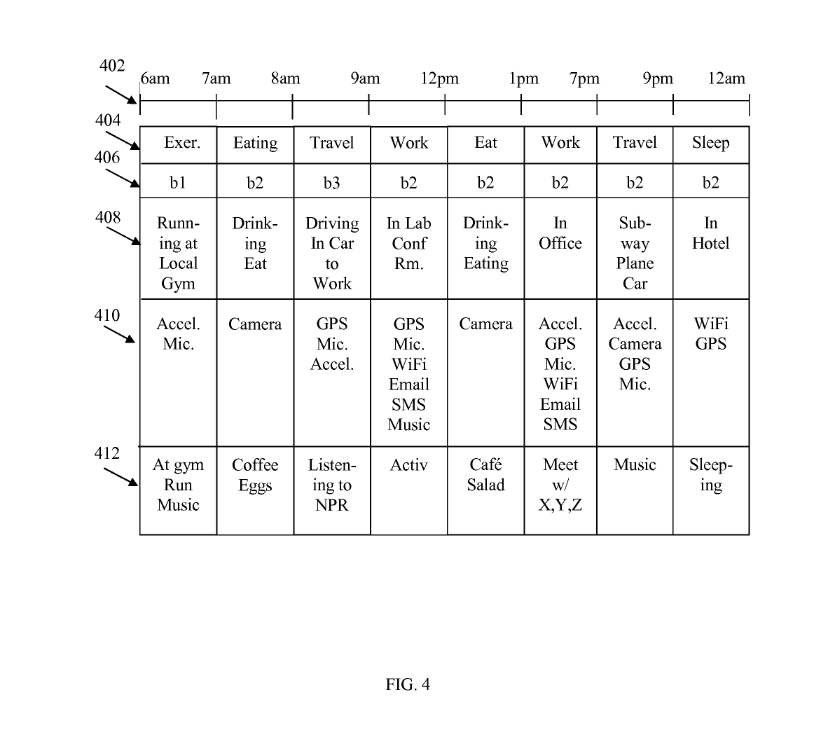

FIG. 4 is a behavior vector timeline representing a portion of an example user's behavior on an average day. The data shown may be populated and/or used in accordance with this disclosure, e.g., in accomplishing steps 304-312 in FIG. 3. FIG. 4 shows a timeline 402 mapping an example user's behavior in a behavior field 404 during different times of the day. As used herein, behavior may be defined as generalized categories of conduct, habits, routines, and/or repeated user actions, e.g., working, sleeping, eating, traveling. Thus, FIG. 4 shows a user exercising from 6 am-7 am, eating from 7 am-8 am, traveling from 5 am-9 am, working from 9 am-12 pm, eating from 12 pm-1 pm, working from 1 pm-7 pm, traveling from 7 pm-9 pm, and sleeping from 9 pm-12 am. Behavior vector field 406 represents the behavior vector assignment associated with the observed behaviors. As used herein, behavior vectors may be alpha-numeric codes associated with particular user behaviors to assist in behavior modeling. Behavior vectors may be useful in aggregating and analyzing patterns of conduct, e.g., for predictive analysis. For example, looking for patterns with behavior vector analysis may enable extracting implied information, e.g., individual preferences, to simplify conclusions about the future. State field 408 shows different user states associated with each behavior. As used herein, states may be defined as the discrete real-world activities being performed by the user, e.g., running at a local gym, eating and drinking at a café, working in a lab or conference room, sleeping in a hotel, etc. States may be coupled with an objective of the behavior, e.g., driving to San Francisco, riding to the airport in a subway, traveling by plane to Abu Dhabi, etc. Device field 410 shows example sensors on a mobile device, e.g., MN 100 of FIG. 1, which may be used to obtain state and/or behavior data using one or more low-level sensors. As used herein, low-level sensors may include temperature, light, and GPS and may be referred to using the nomenclature l1, l2, and l3 (e.g., lower case “L” followed by a numeral), and may pass data to the mobile device via a sensor control interface, e.g., sensor control interface 202 of FIG. 2. Example low-level sensors include GPS receivers, accelerometers, microphones, cameras, WiFi transmitters/receivers, e-mail clients, SMS clients, Bluetooth transmitters/receivers, heart rate monitors, light sensors, etc. Other low level sensors may be referenced with similar nomenclature. Mid-level application may include, e.g., SMS, email, telephone call applications, calendar applications, etc., and may be referred to using the nomenclature m1, m2, m3, etc. High-level activity may include, e.g., using search engines, social media, automated music recommendations services, mobile commerce (M-Commerce), etc., and may be referred to using the nomenclature h1, h2, h3, etc. Thus, as referred to in 304 of FIG. 3, data fusion algorithms may fuse data (l1+m1+h1) in time intervals (t₀, t₁) to identify behavior vectors, permitting development of predicted actions and ultimately anticipation of users' needs. Predicted Action field 412 shows example predicted actions, e.g., anticipated conduct based on the sensor information, state information, and behavior vector, as may be determined by a processing engine on the mobile device, e.g., computation engine 206 of FIG. 2.

FIG. 5 is a flowchart illustrating a method 500 of execution of an action based on a predicted user behavior. Method 500 may be carried out on a device instantiating a user behavior modeling platform, e.g., user behavior modeling platform 200 of FIG. 2. Method 500 may begin at 502 with a sensing and monitoring phase during which a device, e.g., MN 100 of FIG. 1, collects data from various sources, e.g., low-level sensors, apps, e.g., apps 210 and 212 of FIG. 2, the device itself, and/or from the user. At 504, the device may conduct an analysis of context-features to determine a user's current state, e.g., using steps 304-314 of FIG. 3. At 506, the device may utilized learned traits, behavior vectors, patterns etc., to predict the user's needs based on a state transition model, e.g., by reviewing the next pattern-proximate expected behavior or reviewing behaviors associated with the objective of the then-current state. At 508, the device may retrieve the user state transition model and may develop instructions to (1) execute an action (2) based on the predicted need (3) at a given user state Z as determined by step 506. The actions executed may include utilizing mid-level and/or high-level applications to anticipate and fulfill a perceived need. For example, the action may include a contextual power management scheme, during which the device (1) disables, closes, deactivates, and/or powers-down certain software or hardware applications, e.g., a GPS antenna, (2) due to a low likelihood of expected usage (3) because the user is sleeping/immobile. Alternately, the action taken may include (1) generating an alert notification for a meeting (2) because the user is in traffic (3) sitting in a car an hour away. In certain embodiments, the action may comprise multiple steps. For example, following a data collection weather query, the action may include (1a) suggesting an alternate route, (1b) suggesting protective clothing, and (c) suggesting en route dining options (2) based on inclement weather (3) at the vacation house to which the user is driving. In other embodiments, the predicted needs may account for multiple variables, e.g., (1) suggesting a particular variety of restaurant (2) based on (a) the time of day and (b) the eating preferences of multiple persons in a party (3) walking along a boardwalk.

FIG. 6 is a flowchart 600 showing an example use of a user behavior modeling platform, e.g., the user behavior modeling platform 200 of FIG. 2. At 602, the platform may understand and predict the user's behavior using a disclosed embodiment, e.g., method 500 of FIG. 5. At 604, the platform may offer personalized services based on mobility predictions, e.g., where the user is/is going/likely to go. For example, the platform may understand that the user is going out to dinner and may send lunch coupons, make reservations, provide directions to a commercial establishment, suggesting retailers or wholesalers, etc. In another example, the platform may understand that the user is driving home and may send remote climate control instructions to the user's home thermostat to adjust the climate control to the user's preference. In yet another example, the platform may understand that the user is working late in the office and may suggest food delivery options.

FIG. 7 is a flowchart 700 showing another example use of a user behavior modeling platform, e.g., the user behavior modeling platform 200 of FIG. 2. At 702, the platform may understand and predict the user's behavior using a disclosed embodiment, e.g., method 500 of FIG. 5. At 704, the platform may identify a physical traffic management objective and may suggest a traffic-managed alternate route and/or rerouting via an alternate path. For example, the platform may suggest an alternate driving route based on construction, traffic accidents, crimes, inclement weather, desirable sightseeing locations, etc. In another example, the platform may suggest an alternate walking route based on epidemiological concerns, crime reports, income levels, personal conflicts, inclement weather, to maximize WiFi and/or cell network coverage, etc.

FIG. 8 is a flowchart 800 showing still another example use of a user behavior modeling platform, e.g., the user behavior modeling platform 200 of FIG. 2. At 802, the platform may understand and predict the user's behavior using a disclosed embodiment, e.g., method 500 of FIG. 5. At 804, the platform may suggest one or more conditional routines based on user events. For example, the platform may suggest sending a text message to a spouse if traffic on the drive home makes a timely arrival unlikely. In another example, the platform may call an emergency service with location information if the platform senses a high-velocity impact of a user's mode of transportation.

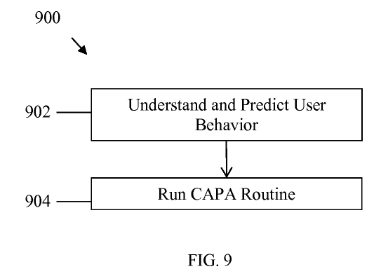

FIG. 9 is a flowchart 900 showing yet another example use of a user behavior modeling platform, e.g., the user behavior modeling platform 200 of FIG. 2. At 902, the platform may understand and predict the user's behavior using a disclosed embodiment, e.g., method 500 of FIG. 5. At 904, the platform may run a CAPA routine to conserve battery life based on a predicted behavior pattern. Thus, the platform may disable one or more software applications and/or hardware features to conserve battery when a state indicates that the software application and/or hardware feature is not likely to be utilized. For example, the platform may disable all background software applications based on sensing a user sleeping. In another example, the platform may disable WiFi when the user is in a car, disable GPS when the user is expected to remain stationary, e.g., at work, at home, inside a plane, etc., and/or disable one or more communication antennas when communication over the applicable medium is unlikely.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. All documents described herein are incorporated herein by reference.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A mobile device for modeling user behavior comprising:
at least one sensor for sensing a parameter;
a memory;
a processor coupled to the sensor and the memory, wherein the memory contains instructions that when executed by the processor cause the apparatus to:
collect data from the sensor;
fuse the data with a time element to obtain a context-feature;
determine a first state based on the context-feature;
record the first state in a state repository, wherein the state repository is configured to store a plurality of states such that the state repository enables time-based pattern identification, and wherein each state corresponds to a user activity;
incorporate time-based pattern identification information into a behavior model; and
predict an expected user behavior based on the behavior model.

2. The mobile device of claim 1, wherein the sensor is a sensor for sensing geographic location, a sensor for sensing physical motion, or a sensor for sensing light, sound, or temperature.

3. The mobile device of claim 1, wherein fusing the data comprises utilizing a Kalman Filter approach, a Bayesian algorithm, or a Correlation regression.

4. The mobile device of claim 1, wherein incorporating time-based pattern identification information into a behavior model comprises utilizing a k-mean algorithm, a Hidden Markov model, or a conditional random field, and wherein recording the first state in the state repository comprises updating a state transition model using a state transition algorithm or a harmonic search.

5. The mobile device of claim 1, wherein the sensor is a sensor for sensing performance of a plurality of software applications on the apparatus with respect to at least one of the following metrics: frequency of use, power consumption, processor demand, random access memory (RAM) demand, background usage duration, and foreground usage time.

6. The mobile device of claim 1, wherein the context-feature is selected from a group consisting of: location, software applications in use, travel mode, activity data, and environment.

7. The mobile device of claim 1, wherein execution of the instructions further causes the apparatus to execute an action based on the expected behavior.

8. The mobile device of claim 7, wherein the action is selected from a group consisting of: offering personalized services, suggesting traffic-managed alternate routes, sending a communication to a contact from a contact list, sending a communication to an emergency service, sending an instruction to a remote device, and running a context-aware power management routine, and wherein the personalized services include services selected from a group consisting of:
offering coupons, making reservations, and providing directions to a commercial establishment.

9. The apparatus of claim 1, wherein predicting the expected user behavior comprises selecting the expected user behavior from a preference correlation data set developed using a plurality of other users' behaviors.

10. The apparatus of claim 1, wherein incorporating time-based pattern identification information into the behavior model comprises performing a pattern recognition analysis to identify sequential patterns for predictive analysis.

11. The apparatus of claim 1, wherein predicting the expected user behavior comprises performing a first behavior vector analysis to extract implied information regarding user preferences and incorporating the implied information into a second behavior vector analysis.

12. A method of modeling user behavior for a platform on a mobile device, comprising:
collecting a time-based data from a plurality of sensors;
analyzing the data to determine a plurality of states, wherein each state corresponds to a real-world activity being performed by a user;
recording the plurality of states in a state repository;
incorporating information about the plurality of states into a behavior model, wherein building the behavior model comprises applying one or more behavior algorithms to the state repository in order to identify one or more behavior patterns;
predicting an expected user behavior based on the behavior model; and
sending instructions to perform an action to at least one hardware component, software application, or both based on the expected behavior.

13. The method of claim 12, wherein the sensors include two or more sensors selected from a group consisting of: geographic position sensors, physical motion sensors, acoustic sensors, optical sensors, and temperature sensors.

14. The method of claim 12, wherein determining at least one state requires utilizing context-features, and wherein the context-features are selected from a group consisting of: location, software applications in use, travel mode, activity data, and environment.

15. The method of claim 12, wherein applying the one or more behavior algorithms comprises utilizing one or more techniques selected from a group consisting of: vector quantization algorithms, Hidden Markov Models (HMM), Bayes filtering, naïve Bayes classifiers, expectation-maximization for learning travel patterns from geographic location sensors, k-Nearest Neighbor (k-NN), support vector machines (SVM), and decision trees or decision tables for classifying the activity of a user based on accelerometer readings.

16. The method of claim 12, wherein the instructions inform the at least one hardware component, software component, or both to perform one or more of the following actions:
disabling, closing, deactivating, and powering-down.

17. The method of claim 12, wherein predicting the expected user behavior comprises selecting the expected user behavior from a preference correlation data set developed using a plurality of other users' behaviors.

18. The method of claim 12, wherein incorporating information about the plurality of states into a behavior model comprises performing a pattern recognition analysis to identify sequential patterns for predictive analysis.

19. The method of claim 12, wherein predicting the expected user behavior comprises performing a first behavior vector analysis to extract implied information regarding user preferences and incorporating the implied information into a second behavior vector analysis.

20. A computer program product for modeling user behavior comprising computer executable instructions stored on a non-transitory medium that when executed by a processor cause the processor to:
collect data from a mobile device over a time interval, wherein the data comprises low-level, mid-level, and high-level data;
fuse the data with time information to create a plurality of context-features;
utilize the plurality of context-features to determine a plurality of states, wherein each state corresponds to a real-world activity being performed by a user;
record the plurality of states in a state repository;
incorporate information stored in the state repository into a behavior model, wherein building the behavior model comprises applying one or more behavior algorithms to the state repository in order to identify one or more behavior patterns; and
identify an action to be taken by the mobile device based on an expected state, wherein the expected state is based on the behavior model.

21. The computer program product of claim 20, wherein the instructions further cause the processor to perform the action based on sensing a current state not matching the expected state.

22. The computer program product of claim 20, wherein the instructions further cause the processor to perform the action, and wherein the action is selected from a group consisting of: offering personalized services, suggesting traffic-managed alternate routes, sending a communication to a contact from a contact list, sending a communication to an emergency service, sending an instruction to a remote device, and running a context-aware power management routine, and wherein the personalized services include services selected from a group consisting of: offering coupons, making reservations, and providing directions to a commercial establishment.

23. The computer program product of claim 20, wherein the low-level data comprises data selected from a group consisting of: global positioning system (GPS) data, accelerometer data, microphone data, camera data, wireless fidelity (WiFi) data, e-mail client data, short message service (SMS) client data, Bluetooth data, heart rate monitor data, and light sensor data, wherein the mid-level data comprises data selected from a group consisting of: SMS software application data, email software application data, telephone software application data, and calendar software application data, and wherein the high-level data comprises data selected from a group consisting of: search engine usage data, web browser usage data, social media usage data, music service data, and mobile commerce (M-Commerce) data.

24. The computer program product of claim 20, wherein applying the one or more behavior algorithms comprises utilizing one or more techniques selected from a group consisting of: vector quantization algorithms, Hidden Markov Models (HMM), Bayes filtering, naïve Bayes classifiers, expectation-maximization for learning travel patterns from geographic location sensors, k-Nearest Neighbor (k-NN), support vector machines (SVM), and decision trees or decision tables for classifying the activity of a user based on accelerometer readings.

25. The computer program product of claim 20, wherein collecting the plurality of data comprises receiving the plurality of data from a remote location.

26. The computer program product of claim 20, wherein the action comprises instructing at least one hardware component, software component, or both to perform one or more of the following actions: disabling, closing, deactivating, and powering-down.

27. The computer program product of claim 20, wherein the expected state is selected based on a preference correlation data set developed using a plurality of other users' behaviors.

28. The computer program product of claim 20, wherein incorporating information stored in the state repository comprises performing a pattern recognition analysis on the plurality of states to identify sequential patterns for predictive analysis.

29. The computer program product of claim 20, wherein identifying the one or more behavior patterns comprises performing a first behavior vector analysis to extract implied information regarding user preferences and incorporating the implied information into a second behavior vector analysis.
